(19) United States
(12) Patent Application Publication
(10) Pub. No.: US 2013/0332178 A1
(43) Pub. Date: Dec. 12, 2013

(54) BUSINESS SCENARIO BASED SCOPING

(71) Applicants: Jiangtao Zhong, Shanghai (CN); Harald Hengelbrock, Shanghai (CN); Yingjie Han, Shanghai (CN); Cheng Wang, Shanghai (CN); Frank Wagner, Diehlheim (DE)

(72) Inventors: Jiangtao Zhong, Shanghai (CN); Harald Hengelbrock, Shanghai (CN); Yingjie Han, Shanghai (CN); Cheng Wang, Shanghai (CN); Frank Wagner, Diehlheim (DE)

(73) Assignee: SAP AG, Walldorf (DE)

(21) Appl. No.: 13/526,273

(22) Filed: Jun. 18, 2012

(30) Foreign Application Priority Data
Jun. 7, 2012 (CN) 201210186018.6

(51) Int. Cl. G06Q 10/00

(52) U.S. Cl. 705/1.1

(57) ABSTRACT

An enterprise management software system that provides configuring scoping elements based on business scenario. The enterprise management software system may executed on computing devices to perform a method. The method may comprise providing an option to perform scoping by business scenario, and upon selection of scoping by business scenario, displaying a plurality of pre-defined business scenarios. Further, the method may comprise displaying a process flow of the selected pre-defined business scenario upon selection of a pre-defined business scenario, and providing immediate changes to scoping elements based on the selected pre-defined business scenario.

### RELATED APPLICATIONS

This application claims priority to Chinese Patent Application No. 201210186018.6, filed Jun. 7, 2012, the contents of which are herein incorporated in its entirety by reference.

### BACKGROUND

Modern enterprises such as governmental organization and private businesses typically use computer systems to manage their operations. Among the computer systems, enterprise management systems are computerized systems that define processes and protocols for various business operations. By using enterprise management systems, public and private organizations can define processes that are to be undertaken during performance of the organization's operations which can be applied uniformly among a large set of employees.

The enterprise management systems typically implement pre-defined common business processes. In addition, some customers usually demand the enterprise management systems to be tailored for their specific business processes. Thus, the enterprise management systems are normally shipped to customers with the pre-defined common business processes and/or customer specific business processes. Once delivered to a customer, the conventional enterprise management systems typically only provide configuration options in various business areas. For example, a conventional enterprise management system only allows end users to configure marketing, sales, sourcing, purchasing, etc., individually. However, users use the enterprise management systems to perform various business processes across different business areas. Therefore, there is a need in the art to provide configuration access via the user interface based on business processes.

### BRIEF DESCRIPTION OF THE DRAWINGS

FIG. 1 is a user interface (UI) for an enterprise management system that provides business scenario based scoping according to an exemplary embodiment of the present invention.

FIG. 2 is a user interface (UI) for an enterprise management system that provides business scenario based scoping according to an exemplary embodiment of the present invention.

FIG. 3 is a user interface (UI) for an enterprise management system that provides business scenario based scoping according to an exemplary embodiment of the present invention.

FIG. 4 is a user interface (UI) for an enterprise management system that provides business scenario based scoping according to an exemplary embodiment of the present invention.

FIG. 5 illustrates a method to provide a business scenario based scoping according to an embodiment of the present invention.

FIG. 6 illustrates a computer system according to an embodiment of the present invention.

FIG. 7 is a simplified block diagram of a computer network suitable for use with the present invention.

### DETAILED DESCRIPTION

Embodiments of the present invention provide an enterprise management software system that provides configuration of scoping elements based on business scenario. The enterprise management software system may executed on computing devices to perform a method. The method may comprise providing an option to perform scoping by business scenario, and upon selection of scoping by business scenario, displaying a plurality of pre-defined business scenarios. Further, the method may comprise, upon selection of a pre-defined business scenario, displaying a process flow of the selected pre-defined business scenario, and providing immediate changes to scoping elements based on the selected pre-defined business scenario.

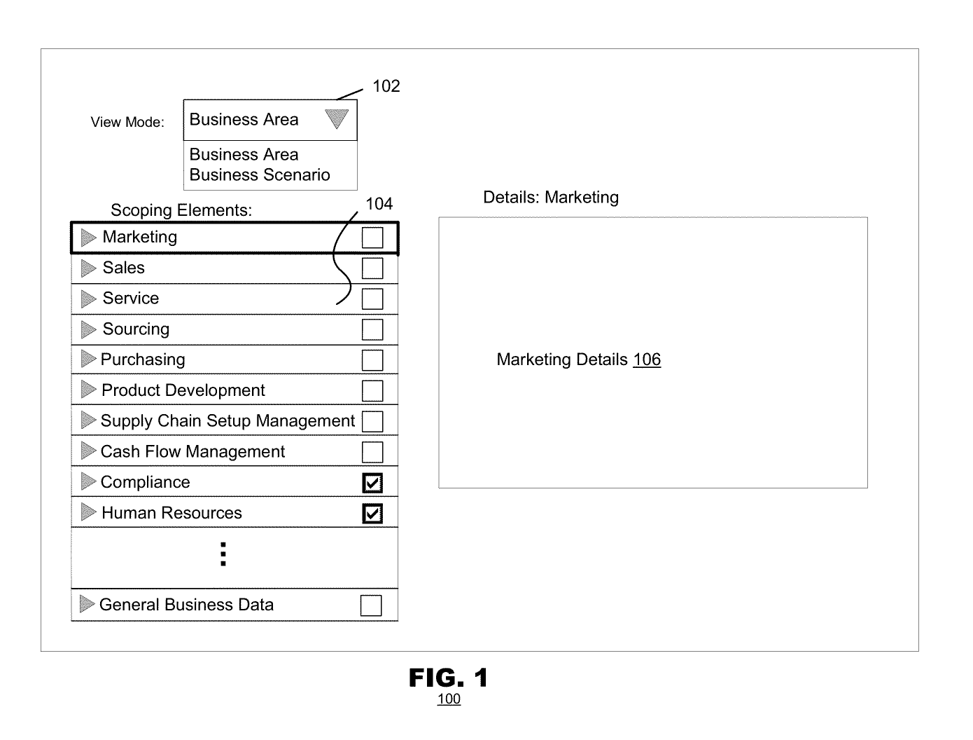

FIG. 1 illustrates a user interface (UI) 100 for an enterprise management system that provides business scenario based scoping according to an exemplary embodiment of the present invention. The UI 100 may comprise a drop down box 102 for a plurality of options for view modes, a table 104 for scoping elements according to the selected view mode in the drop down box 102 and a panel 106 showing details for a scoping element in the table 104 that currently has the focus. In one or more embodiments, scoping means making a business scope decision basing on or using business scenario. For example, if the customer would like to apply the business scenario ‘Sell from Stock’, then the related business functions/scope may be activated in the system after the deployment. A scoping element may be a base element defined at design time (by software application vendor) via which the related business functions/scope may be activated in Runtime applications.

The plurality of options for view modes may include “Business Area” and “Business Scenario.” Business areas may be grouped by functions within a business. As shown in FIG. 1, when the Business Area being selected in the drop down box 102, a list of business areas may be displayed. The list may include: marketing, sales, service, sourcing, purchasing, product development, supply chain management, cash flow management compliance, human resources, general business data, etc. This list is non-exhaustive and other business areas may be included as well. Each business area may be further expanded to show its respective sub-business areas by clicking on a button to its left (e.g., the triangle). Further, each business area involved in a currently being configured business process may be indicated by a check box to its right. For example, compliance and human resources business areas may be involved in the current business process being configured.

In one embodiment, the list of scoping elements 104 may be displayed in a hierarchy and referred to as a business adaptation catalog (BAC). The business adaptation catalog may be organized as a BAC tree either by business area or business scenario. In an embodiment, the BAC tree may be organized by business area by default. Alternatively, the BAC tree may be organized by business scenario by default.

The panel 106 may display information and/or configuration options for a scoping element in the table 104 that currently has the focus. As shown in FIG. 1, the “marketing” business area in the list of scoping elements 104 may currently have the focus (e.g., marked in bold rectangle). Thus, the panel 106 may display information and/or configuration options for the “marketing” business area.

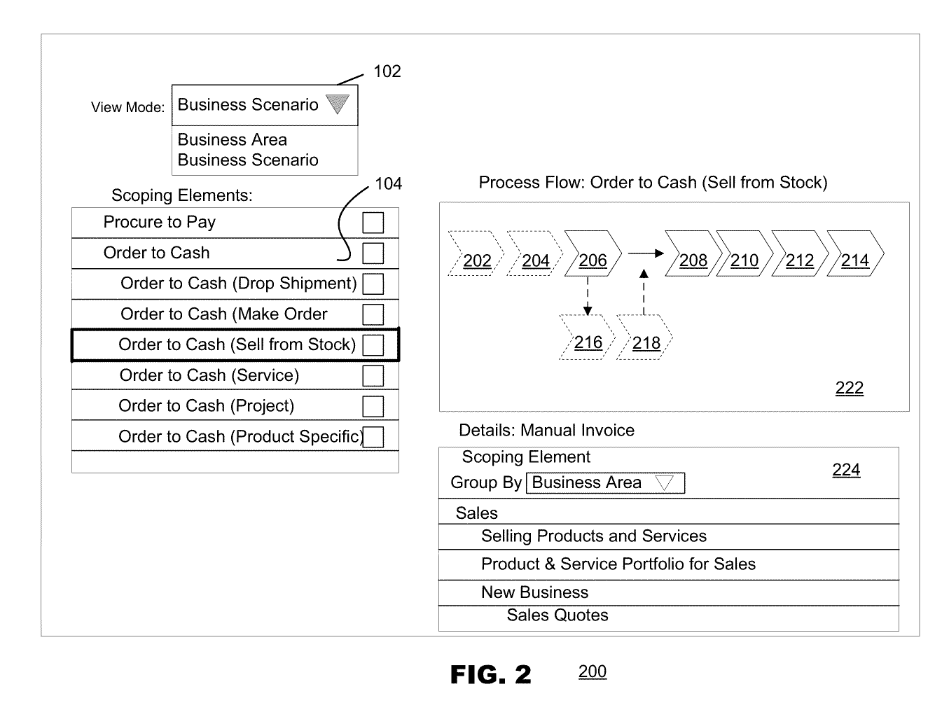

FIG. 2 illustrates a user interface (UI) 200 for an enterprise management system that provides business scenario based scoping according to an exemplary embodiment of the present invention. The UI 200 may be a different display of the UI 100 when a user chooses business scenario for the view mode in the drop down box 102. The list 104 of the BAC tree may be organized by business scenario. For example, a list of business scenario groups may be listed, such as “procure to pay,” and “order to cash.” The BAC tree may also have a next level of business scenarios under each business scenario groups. For example, as shown in FIG. 2, order to cash business scenario group may include: order to cash (drop shipment), order to cash (make to order), order to cash (sell from stock), order to cash (services), order to cash (project), order to cash (product specific), etc.

The UI 200 may comprise a display pane 222 for displaying a process flow for a business scenario currently in focus (e.g., being configured) and a details panel 224 showing details of scoping elements that support the business scenario. For example, after a user selects a scenario in the BAC tree in the left side, the process flow of the selected business scenario may be presented in the right side in the display pane, each process in the selected business scenario may include a textual description on the UI 200 to explain in detail what may be done in this process.

The process flow showing in the display pane 222 may include a plurality of default processes (in solid lines) and a plurality of optional processes (in dash lines). As shown in FIG. 2, the process flow for “order to cash—sell from stock” may comprise default processes of 206, 208, 210, 212 and 214 and may also comprise optional processes of 202, 204, 216 and 218. In one embodiment, the default processes 206, 208, 210, 212 and 214 may be “creating sales order,” “initiate outbound processing,” “outbound delivery processing,” “creating customer invoice,” and “processing receivable and payments,” respectively. The optional processes 202, 204, 216 and 218 may be “managing incoming customer inquiry,” “creating sales quotes,” “creating down payment request,” and “processing receivable and payments,” respectively. In one or more embodiments, an optional processes may be activated, for example, by a pop up menu when the optional process being right clicked using a mouse.

The details panel 224 may show the scoping element as grouped by business area or business scenario. As shown in FIG. 2, for the scoping element of “sales,” sub-area may be listed. The sub-areas may include, for example, selling products and services, product & service portfolio for sales. In one embodiment, some other scoping elements, such as “new business”->“sales quotes” may be automatically added to the list after some optional processes are activated. For example, when software vendors may provide runtime application functions assigned/mapped to certain scoping elements in business configuration at design time, when any one of the scoping elements is added or enabled in a business scenario, the corresponding runtime functions may be enabled.

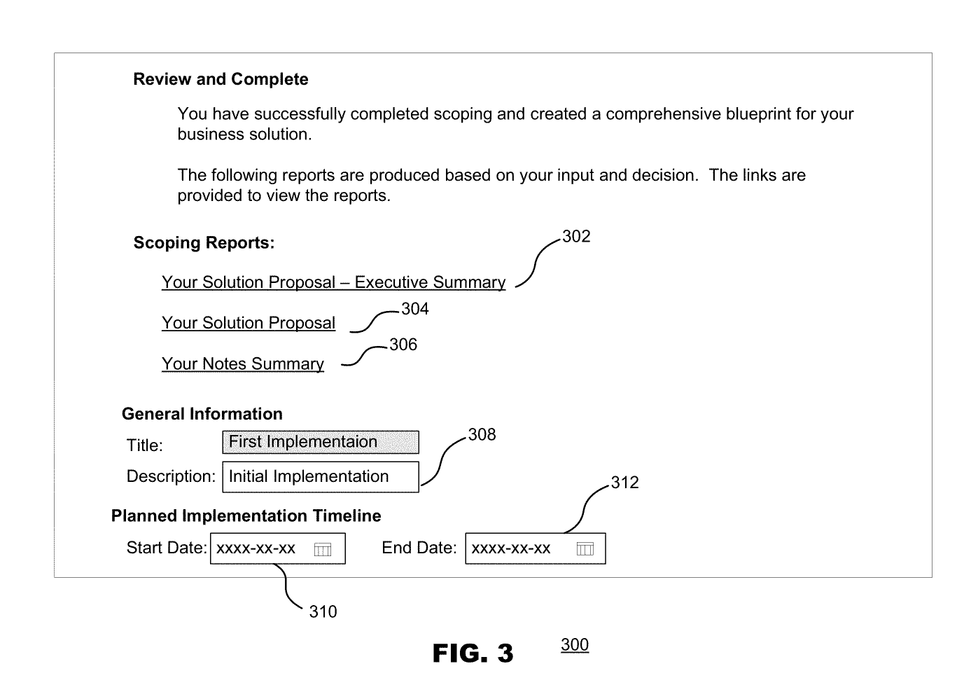

FIG. 3 illustrates a user interface (UI) 300 for an enterprise management system that provides business scenario based scoping according to an exemplary embodiment of the present invention. The UI 300 may be a review UI for an exemplary embodiment of the enterprise management system that implements business scenario based scoping. The UI 300 may include links to scoping reports, for example, executive summary 302, proposal 304 and notes summary 306. The UI 300 may also include a text box 308 for description of the project, text boxes 310 and 312 for start date and end date of the project. In one embodiment, the executive summary may include a section to summary the available business scenarios and function aspects. The textboxes for the start date and end date may include buttons that when clicked may show a active calendar (dates may be selected directly on the calendar) to facilitate entering of dates. In one or more embodiments, creation of a business process may be referred to as a project. The project may be used to define the business scope and fine-tuning some application configuration settings. For example, after a business scope has been defined during scoping, some activities may be generated together with the scope decisions within this project. Then team members within this project may perform fine tuning to the configuration settings via those activities, for example, persons working on Finance area may perform fine tuning to the settings in Chart of Account, persons working on Logistics may perform fine tuning to the shipping address etc.

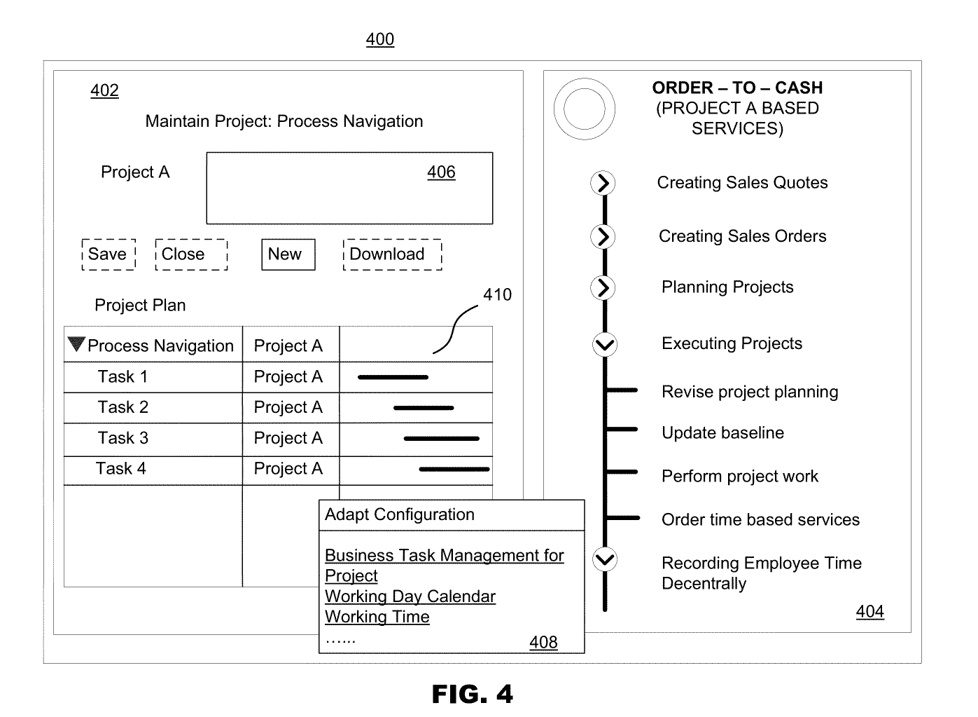

FIG. 4 illustrates a user interface (UI) 400 for an enterprise management system that provides business scenario based scoping according to an exemplary embodiment of the present invention. The UI 400 may comprise a process navigation display panel 402, a project flow tree 404 and a pop up menu 408. The process navigation display panel 402 may show information about a project (e.g., Project A) in a pane 406. The information may include status, whether the project is on hold, start date and finish date, etc. The process navigation display panel 402 may further include a plurality of function buttons, for example, to save the configuration/information update of the project, close the current project, start a new project and/or download an existing project. In one or more embodiments, one or more buttons may be disabled. For example, the save button may be disabled (shown in dashed lines) and only enabled when all necessary information or configuration are completed. The process navigation display panel 402 may also include a project plan panel 410. The project plan panel 410 may list a plurality of tasks in the current project (e.g., Project A) and timelines for each of the tasks.

The project flow tree 404 may show a flow of the project being configured on the process navigation display panel 402. For example, as shown in FIG. 4, the project flow tree 404 may show a project flow of an order to cash flow for project A based services. The project flow tree 404 may include a plurality of top level processes (e.g., creating sales quotes, creating sales orders, planning projects, executing projects or recording employee time decentrally). Each top level process may include a plurality of sub-level processes. For example, under the executing project top level process, there may be sub-level processes of revise project planning, update baseline, perform project work and order time based services.

The pop up menu 408 may support making changes to any scoping elements directly based on the business scenario. As shown in FIG. 4, a plurality of actions may be performed via the pop up menu. For example, the pop up menu 408 may include links for business task management for project, adjusting working day calendar, adjusting working time, etc.

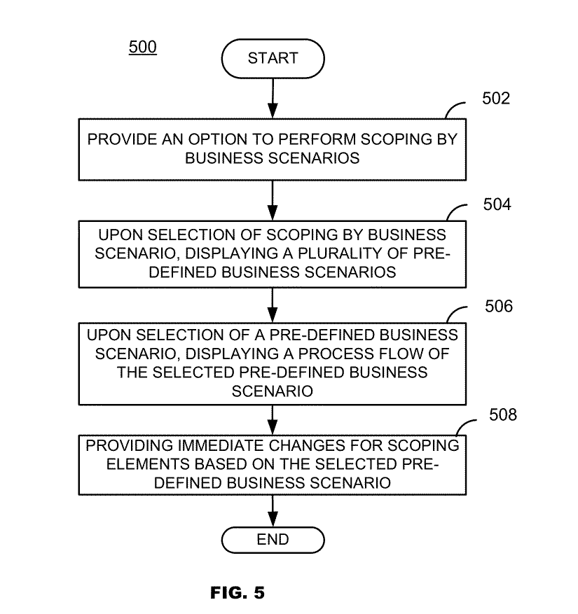

FIG. 5 illustrates a method 500 to provide a business scenario based scoping according to an embodiment of the present invention.

At block 502, an option to perform scoping by business scenario may be provided. In one embodiment, scoping may include deciding which functionalities to be activated in a Runtime application.

At block 504, upon selection of scoping by business scenario, the method 500 may display a plurality of pre-defined business scenarios. As described above, a BAC tree may be organized by business area or business scenario. Organized by business area may be set by default but the tree may be re-organized upon selection of the view mode to business scenario. At block 506, upon selection of a pre-defined business scenario, the method 500 may display a process flow of the selected pre-defined business scenario. In one embodiment, the process flow may include pre-defined default processes and optional processes that may be activated by a user. At block 508, the method 500 may provide immediate changes to scoping elements based on the selected pre-defined business scenario.

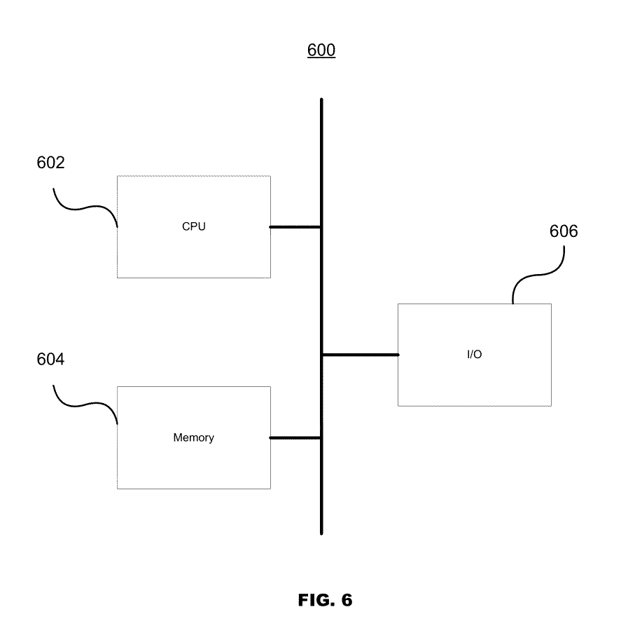

FIG. 6 illustrates a computer system 600 according to an embodiment of the present invention. The computer system 600 may represent a computing device that implements an embodiment of the enterprise computer system according to one embodiment. The computer system 600 includes a processor 602, memory 604, and an I/O device(s) 606. The processor 602 is connected to the memory 604 and I/O device(s) 606. These connections are direct or via other internal electronic circuitry or components.

The processor 602 is a programmable processor that executes instructions residing in the memory 604 to receive and send data via the I/O device(s) 606. The instructions may perform the operations of a message handling system according to an exemplary embodiment. The term programmable processor as used herein is any programmable microprocessor or processor or combination of microprocessors or processors that can operate on digital data, which may be special or general purpose processors coupled to receive data and instructions from, and to transmit data and instructions to, a machine-readable medium. According to one embodiment of the present invention processor 602 is an Intel® microprocessor.

Memory 604 is a machine-readable medium that stores data that is processed by processor 602. The term machine-readable medium as used herein is any addressable storage device that stores digital data including any computer program product, apparatus and/or device (e.g., a random access memory (RAM), read only memory (ROM), magnetic disc, optical disc, programmable logic device (PLD), tape, hard drives, RAID storage device, flash memory or any combination of these devices). This may include external machine-readable mediums that are connected to processor 602 via one or more I/O device(s) 606.

The I/O device(s) 606 may be one or more input/output interfaces that receive and/or send digital data to and from an external device. Interfaces as used herein are any point of access to an external device where digital data is received or sent, including ports, buffers, queues, subsets thereof, or any other interface to an external device.

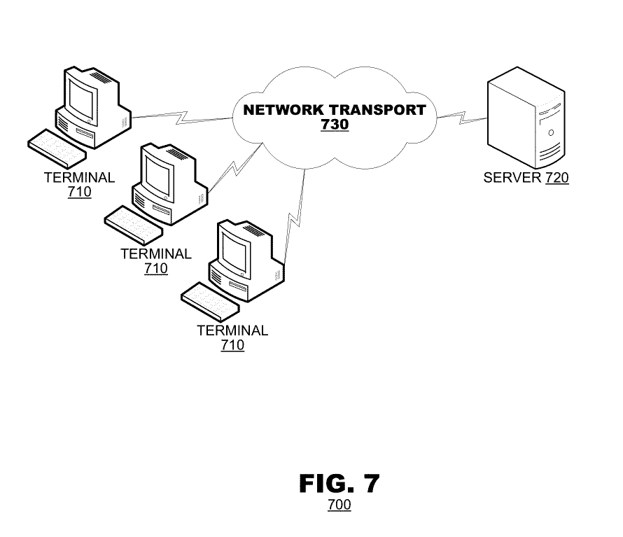

FIG. 7 is a simplified block diagram of a computer system 700 suitable for use with the present invention. The system 700 may include a number of terminals 710 connected to one or more servers 720 via a network 730. The terminals 710, and servers 720 collectively execute a number of applications, which include executable code and various data sets. For example, the server 720 may store data to be provided to various applications running at the server 720, the terminals 710. Various users also may view and operate on common, shared data during execution of various applications but this functionality is not shown in FIG. 7. In one or more embodiments, the enterprise software system that implement business scenario based configuration may be hosted on the server 720 with user interfaces presented on the terminals 710. As noted, FIG. 7 is a simplified block diagram of a computer system 700. Unless noted otherwise, the topology and architecture of the system 700 is immaterial to the present discussion unless otherwise noted.

The exemplary method and computer program instructions may be embodied on a machine readable storage medium such as a computer disc, optically-readable media, magnetic media, hard drives, RAID storage device, and flash memory. In addition, a server or database server may include machine readable media configured to store machine executable program instructions. The features of the embodiments of the present invention may be implemented in hardware, software, firmware, or a combination thereof and utilized in systems, subsystems, components or subcomponents thereof. When implemented in software, the elements of the invention are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as Internet, Intranet, etc.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the spirit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

1. A method of configuring scoping elements based on business scenario, comprising:
providing, using a processor, a user interface;
providing, using said processor, an option to perform scoping by business scenario;
upon selection of scoping by business scenario, displaying a plurality of pre-defined business scenarios;
upon selection of a pre-defined business scenario, displaying a process flow of the selected pre-defined business scenario; and
providing immediate changes to scoping elements based on the selected pre-defined business scenario.

2. The method of claim 1, wherein each of the plurality of pre-defined business scenarios includes a plurality of pre-defined processes.

3. The method of claim 2, wherein at least one of the plurality of pre-defined business scenarios further includes at least one optional process.

4. The method of claim 3, wherein the optional process is activatable.

5. The method of claim 4, wherein the optional process is activated by a pop menu upon right click of a mouse.

6. The method of claim 3, wherein when the optional process is activated, relevant scoping elements are automatically added to a list for scoping elements to show more detailed information.

7. A computing device, comprising:
storage for computer program instructions,
a display device, and
a computer processor configured to execute the computer instructions to:
provide, using said computer processor, a user interface;
provide, using said computer processor, an option to perform scoping by business scenario;
upon selection of scoping by business scenario, display a plurality of pre-defined business scenarios;
upon selection of a pre-defined business scenario, display a process flow of the selected pre-defined business scenario; and
provide immediate changes to scoping elements based on the selected pre-defined business scenario.

8. The computing device of claim 7, wherein each of the plurality of pre-defined business scenarios includes a plurality of pre-defined processes.

9. The computing device of claim 8, wherein at least one of the plurality of pre-defined business scenarios further includes at least one optional process.

10. The computing device of claim 9, wherein the optional process is activatable.

11. The computing device of claim 10, wherein the optional process is activated by a pop menu upon right click of a mouse.

12. The computing device of claim 9, wherein when the optional process is activated, relevant scoping elements are automatically added to a list for scoping elements to show more detailed information.

13. A non-transitory computer readable storage medium having stored thereon computer instructions that, when executed by a computing device, cause the computing device to:
provide, using a processor, a user interface;
provide, using said processor, an option to perform scoping by business scenario;
upon selection of scoping by business scenario, display a plurality of pre-defined business scenarios;
upon selection of a pre-defined business scenario, display a process flow of the selected pre-defined business scenario; and
provide immediate changes to scoping elements based on the selected pre-defined business scenario.

14. The non-transitory computer readable storage medium of claim 13, wherein each of the plurality of pre-defined business scenarios includes a plurality of pre-defined processes.

15. The non-transitory computer readable storage medium of claim 14, wherein at least one of the plurality of pre-defined business scenarios further includes at least one optional process.

16. The non-transitory computer readable storage medium of claim 15, wherein the optional process is activatable.

17. The non-transitory computer readable storage medium of claim 16, wherein the optional process is activated by a pop menu upon right click of a mouse.

18. The non-transitory computer readable storage medium of claim 15, wherein when the optional process is activated, relevant scoping elements are automatically added to a list for scoping elements to show more detailed information.

19. A method of configuring scoping elements based on business scenario, comprising:
providing, using a processor, a user interface;
providing, using said processor, a plurality of options including performing scoping by business scenario and scoping by business area;
upon selection of scoping by business scenario, displaying a plurality of pre-defined business scenarios, wherein each of the plurality of pre-defined business scenarios includes a plurality of pre-defined processes;
upon selection of a pre-defined business scenario, displaying a process flow of the selected pre-defined business scenario, wherein the selected pre-defined business scenario includes at least one optional process, when the optional process is activated, relevant scoping elements are automatically added to a list for scoping elements to show more detailed information; and
providing immediate changes to scoping elements based on the selected pre-defined business scenario.

20. The method of claim 19, wherein in the displayed process flow, each pre-defined process and optional process for the selected pre-defined business scenario are displayed with detailed description.
